(19) United States
(12) Patent Application Publication
(10) Pub. No.: US 2007/0286172 A1
(43) Pub. Date: Dec. 13, 2007

(54) xDSL VoIP adapter device

(76) Inventors: Christian S. Duran, Ft. Worth, TX (US); Richard A. Kurita, Denton, TX (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/439,087

(22) Filed: May 23, 2006

(51) Int. Cl. H04L 12/66

(52) U.S. Cl. 370/356

(57) ABSTRACT

Described is an apparatus for permitting installation of voice over internet protocol (VoIP) service at a subscriber premises. A VoIP adapter is provided that is configured to enable application of sealing current to an outside line while permitting use of analog equipment on a VoIP enable premises wiring system. The VoIP adapter includes a high-pass filter portion that permits the use of existing premises analog equipment.

### FIELD OF THE INVENTION

The present invention relates generally to an xDSL Voice over Internet Protocol (VoIP) adapter for use at a subscriber premises. More particularly, the present invention relates to an adapter that is configured to provide signal separation between an outside line and a subscriber's premises wiring while insuring effective sealing current flow through the outside line.

### BACKGROUND OF THE INVENTION

As telephone companies migrate to higher bandwidth services including data and video offerings, the desire to transform the analog Plain Old Telephone Service (POTS) network to a Voice over Internet Protocol (VoIP) network increases. VoIP is a term that has become well recognized recently and relates to methodologies for converting analog audio signals into digital data that may be transmitted over the Internet or other digital data transmission networks including, for example, enterprise intranet networks.

POTS has been in use for some time and, because of its relatively low operating frequencies, operates very compatibly with more recently introduced, concurrently provided, Digital Subscriber Line (DSL) services. DSL service may be provided in a number of configurations that collectively have been designated as “xDSL” to denote all of the various forms. A more common type generally deployed to residential subscriber's premises carries the designation of Asymmetric Digital Subscriber Line (ADSL) service.

More recently, however, DSL service has been proposed to be provided exclusively over the communications lines previously shared with POTS. This data without POTS (also sometimes referred to as “naked DSL”) continues to work well using the same communications lines previously shared with POTS; however certain issues may arise from the provision of exclusively DSL service over previously shared communications lines that were not present when the POTS signal was also present.

Switched loop services such as POTS use direct current (DC) during off-hook conditions for line signaling. In addition to line signaling, a significant benefit arises from the continued presence of the DC on the communications line, that is, the DC assists in preventing oxidation of electrical connections or coupling points. Under normal POTS operation, approximately 20 milliamps (mA) of DC will flow through the switched loop during an off-hook condition. This current is used not only to signal the central office (CO) line card but also to help maintain mechanical splices (which are necessary and unavoidable occurrences in communication lines) essentially clean of oxides or high resistance films. The current flow responsible for oxidation avoidance is often referred to as a sealing current.

In the newly emerging environment of data without POTS, absence of the previously concurrently available switched loop signaling DC introduces certain problems. In particular, the absence of switched loop signaling DC in a data without POTS environment permits mechanical splices to oxidize over a period of time and creates contact problems since the low-level data signals utilized in data without POTS do not carry enough current to properly prevent oxidation.

One positive aspect to the use of VoIP is that such use eliminates the need for Digital Subscriber Line (DSL) splitters in a subscriber premises setting, such as a private residence, apartment building or small business, as well as the need for call signaling and ringing. This positive aspect, however, contributes toward a negative aspect in that without call signaling signals, the low current flow through the loop is no longer available to supply sealing current during off-hook usage. As is well understood by those of ordinary skill in the art, the sealing current previously supplied by the CO during off-hook usage must be provided by other means to keep access lines clear of corrosion.

An additional negative aspect to the provision of data without POTS resides in the circumstance that the majority of subscribers would still like to use a VoIP service with their existing premises wiring as well as their analog telephone hardware including, but not limited to, telephones, facsimile machines, etc. A small number of companies currently provide a device known as a VoIP converter. This device is configured to convert digital Ethernet signals to analog POTS signals and vice versa. A subscriber can use a VoIP converter with a number of telephone instruments that are located close to the converter. In this case the subscriber cannot use existing house wiring. In order to do this, the subscriber would have to re-wire the house wiring and apply a form of high impedance high pass filtering at the network interface device (NID) to prevent POTS signal loss and degradation, and a low pass filter would have to be used at each analog device.

In view of the above mentioned issues involving installation of data without POTS at a subscriber premises, it would be desirable to have an xDSL VoIP electronics package that provides the subscriber with the option of continuing to use her premises wiring and existing analog equipment. While various xDSL and VoIP adapter configurations have been developed, no design has yet emerged that generally encompasses all of the desired characteristics, as hereafter presented in accordance with the present invention.

### SUMMARY OF THE INVENTION

In view of the recognized deficiencies encountered in the prior art and addressed by the present invention, an improved apparatus for providing xDSL VoIP electronics at a subscriber premises has been provided.

In an exemplary configuration, an xDSL VoIP adapter is provided that enables a subscriber to obtain DSL services at her premises while retaining use of existing analog POTS equipment.

In a simple form, xDSL VoIP electronics is provided for mounting in a network interface device, as may commonly be provided at a subscriber premises.

Another positive aspect of this type of adapter is that sealing current may be provided for line oxidation protection even in a data without POTS environment.

In accordance with aspects of certain embodiments of the present invention, apparatus is provided to enable application of a constant sealing current.

In accordance with aspects of other embodiments of the present invention, apparatus is provided to enable application of an intermittent or timed sealing current.

In accordance with yet additional aspects of further embodiments of the present invention, apparatus has been developed to provide a subscriber with xDSL service that also permits the subscriber to implement VoIP service using her existing home wiring.

Additional objects and advantages of the present invention are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the disclosure. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present invention may include various combinations or configurations of presently disclosed features, steps, or elements, or their equivalents (including combinations of features, parts, or steps or configurations thereof not expressly shown in the figures or stated in the detailed description of such figures). Additional embodiments of the present invention, not necessarily expressed in the summarized section, may include and incorporate various combinations of aspects of features, components, or steps referenced in the summarized objects above, and/or other features, components, or steps as otherwise shown or discussed in this disclosure.

It should further be appreciated that while the present disclosure is directed to the installation of xDSL VoIP electronics at a subscriber premises, such is not a limitation of the presently disclosed invention as such electronics may also be installed at locations other than subscriber premises including, for example, larger businesses, office buildings, etc. Those of ordinary skill in the art will better appreciate the features and aspects of such embodiments, and others, upon review of the remainder of this disclosure.

### BRIEF DESCRIPTION OF THE DRAWINGS

A full and enabling disclosure of the present invention, including the best mode thereof, directed to one of ordinary skill in the art, is set forth in this disclosure, which makes reference to the appended figures, in which:

FIG. 1 illustrates an exemplary configuration of an xDSL VoIP adapter installation in a residential environment in accordance with a first embodiment of the present invention;

FIG. 2 illustrates exemplary xDSL VoIP adapter electronics as may be installed at a subscriber premises; and

FIG. 3 illustrates an exemplary circuit for controlling periodic application of sealing current to a telephone line.

Repeat use of reference characters throughout this written disclosure and the appended drawings is intended to represent the same or analogous features or elements of the invention.

### DETAILED DESCRIPTION OF THE PREFERRED EMBODIMENTS

As previously discussed, the present invention is particularly concerned with apparatus for providing xDSL VoIP service at a subscriber's premises while retaining the capability of using existing analog POTS equipment.

Selected combinations of aspects of the present invention correspond to a plurality of different preferred embodiments. It should be noted that each of the exemplary embodiments presented and discussed herein should not insinuate limitations of the present invention. Features or steps illustrated or described as part of one embodiment may be used in combination with aspects of another embodiment to yield still further embodiments. Additionally, certain features may be interchanged with similar devices or features not expressly mentioned which perform the same or similar function.

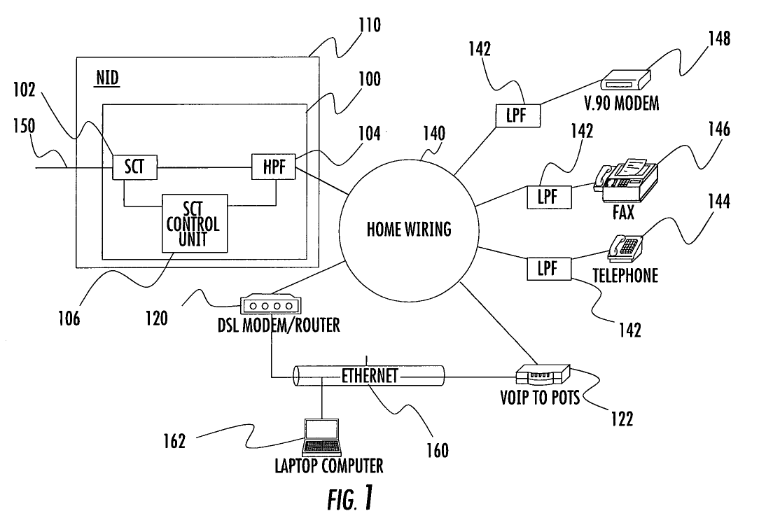

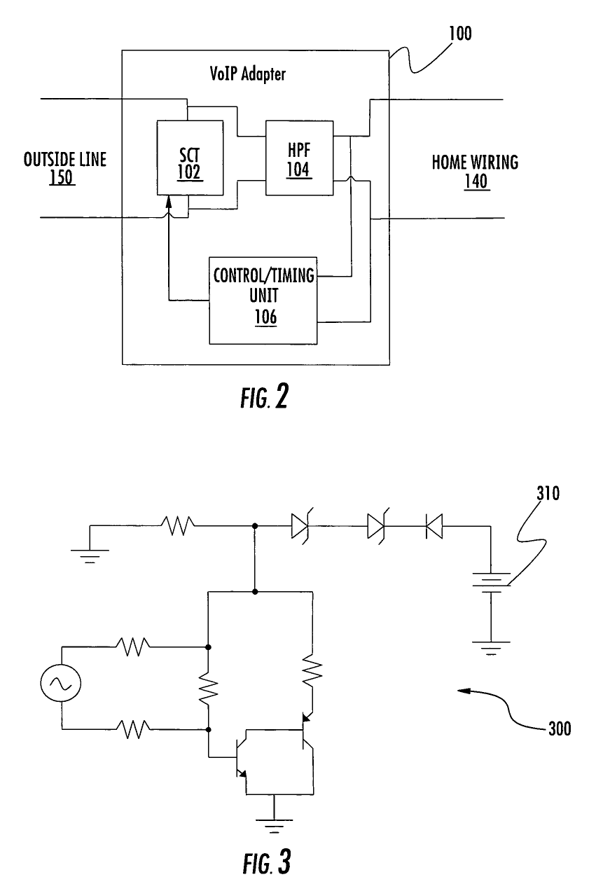

Reference will now be made in detail to the presently preferred embodiments of an xDSL VoIP adapter according to the present invention. Referring now to the drawings, FIG. 1 illustrates an exemplary configuration of an xDSL VoIP adapter installation in accordance with the present invention at a subscriber premises. FIG. 2 illustrates components of an adapter 100 in accordance with the present invention. An adapter 100, constructed in accordance with the present invention may take multiple forms based on specific subscriber and service supplier requirements. In all cases, adapter 100 may be installed in a subscriber premises NID 110. In certain instances, adapter 100 may be provided in a form allowing a subscriber to install adapter 100 in the manner disclosed in commonly assigned U.S. patent application entitled “VoIP ADAPTER FOR NETWORK INTERFACE DEVICE.” In such instances, adapter 100 may be mailed to a subscriber possibly together with additional and optional equipment including, but not limited to, a DSL modem, a VoIP converter, and plug in low pass filters (LPF) as a kit for self-installation.

In accordance with the present invention, different situations may arise resulting from the provision of xDSL service at a subscriber's premises and, in particular, xDSL data service without POTS that give rise to differing configuration requirements for adapter 100. As previously mentioned, the provision of xDSL data service without POTS produces a need to provide line protective sealing current while subscriber interest in continued use of their existing analog POTS equipment requires addition of a high pass filter to isolate the higher frequency that would otherwise be impressed on the subscriber premises wiring and which would be degraded by coupling of analog POTS equipment directly to the premises wiring.

The first concern, that is, lack of sealing current flow, can be addressed by conditioning the local loop with a constant or intermittent DC bias. A constant DC bias is easier to implement and design, however, the costs associated with the technique will drive up the cost of the service since the service providers would have to recoup some of the cost for the constant power being dissipated by each of these devices.

The second concern, that is, the subscriber's desire to continue using existing analog POTS equipment, can be addressed by adding a high pass filter 104 to the NID electronics to permit xDSL signals to pass to a modem 120 while providing a high impedance to newly introduced analog POTS signals from the VoIP to POTS converter 122. The subscriber may then couple the output of a VoIP to POTS converter 122 to any existing telephone connection at their premises in order to introduce converted analog POTS signals into the premises wiring 140. In an exemplary arrangement, coupling of the converted analog POTS signals into the premises wiring 140 may be by way of connection to previously installed RJ-11 and/or RJ-14 jacks coupled to premises wiring 140. Modem 120 may be coupled to VoIP to POTS converter 122 by way of Ethernet 160 to which also additional equipment such as, but not limited to, laptop computer 162 may be coupled.

Since analog POTS signals are located at a different frequency range than DSL signals, there will not be any interference. However, since the POTS devices have been introduced into the premises wiring 140, bridging losses during off-hook conditions will occur absent association of low pass filters 142 with each POTS device 144, 146, 148 either individually as illustrated in FIG. 1 or at a central or splitter location.

In accordance with the present invention, sealing current through outside line 150 may be provided via a sealing current terminator (SCT) 102 that may vary in design depending on specific subscriber/supplier requirements. In a first exemplary configuration in accordance with the present invention, SCT 102 may be configured to allow sealing current to flow at timed intervals during a 24 hour cycle with a hard time reset during an off-hook event.

In this first embodiment, adapter 100 may be provided in a form that produces a timed DC bias to provide an outside line 150 protective sealing current. In such instance, SCT 102 may correspond to a controllable SCT 102 whose termination characteristics are controlled by SCT Control Unit 106. SCT Control Unit 106 may be designed to activate SCT 102 by switching a resistive load across outside lines 150 on a timed basis such that sealing current may flow at least periodically during a 24 hour period. In addition, SCT Control Unit 106 may be configured to sense an off-hook condition from any of the devices 144, 146, 148 coupled to premises wiring 140 to produce a reset of a timer associated with SCT Control Unit 106 such that controlled switching of the SCT 102 may not un-necessarily interfere with actual off-hook conditions.

VoIP adapter 100 can be designed with less complexity with respect to the SCT 102 portion of the adapter 100. While a timed circuit is an efficient solution to providing a sealing current, it is also the most complex solution. The sealing current needs to be supplied to the outside line 150 in a regular fashion. Presently, in POTS service, sealing current is supplied every time the subscriber lifts the handset to make or answer a call. With the use of solid state devices including, but not limited to, diodes and transistors, it is possible to develop a device that will provide sealing current during an off-hook event.

Some service providers have expressed the desire to have sealing current, at lower current levels, supplied constantly. In this instance the VoIP adapter 100 would not need to have a complex control circuit controlling the current sink. Such a configuration would correspond to the most rudimentary system available to the service providers.

The high-pass filter portion of the VoIP adapter 100 is a necessary portion that should be given careful consideration in the choice of values. While complex high-pass filters can be designed, it is important to remember that more complex, that is higher order, filters may tend to cause overshoot in the DSL band. This is a side effect that can cause increased distortion as well as group delay.

Additional protection components including, but not limited to, fuses, gas tubes with failsafe, sidactors, positive temperature coefficient (PTC) or fusible resistors, may be added into the circuit design to provide additional secondary protection and improve performance. Any combination of these components could be used to meet certain requirements. In an exemplary configuration, a smaller fuse, sidactors, gas tube with or without failsafe or a PTC could be added to meet Underwriters Laboratory (UL) requirements. In order to meet more stringent requirements, combinations of any of the above named components may be used. Protective elements as here described may be coupled in various combinations as line to line, and line to ground including both tip to ground and ring to ground configurations as is well understood by those of ordinary skill in the art.

With further reference to FIG. 1, and in view of the previously noted range of potential subscriber/supplier sealing current requirements, there may be provide a number of optional configurations for the sealing current termination control unit 106. In a first exemplary embodiment, SCT control unit 106 may correspond to a mechanical switching configuration controlled by diodes. In such embodiment, when a telephone connection to home wiring 140 goes into an off-hook condition, the voltage supplied to the home wiring 140 by the VoIP converter 122 drops from a range of 45 to 50 volts to a range of 7 to 14 volts. Upon this drop in voltage, an avalanche diode coupled to the control coil of a relay prevents current flow through the control coil and thus maintains otherwise opened relay contacts in the sealing current terminator in a closed contact position. Once current through the control coil of the relay ceases, the relay contacts close and sealing current is applied to the loop.

When the telephone handset returns to an on-hook state, the voltage produced by VoIP converter 122 rises and current flow into the coil of the control relay energizes the control coil and opens the relay contacts thereby preventing sealing current from flowing. In some instances it may be desirable to install over voltage protective rectifier diodes to prevent high voltage ringing signals from destroying the switch.

With reference now to FIG. 3, a second embodiment of a sealing current control circuit employing switching controlled by transistors will be described. An exemplary transistor switching circuit that may be employed with the present invention is illustrated in FIG. 3. Switching occurs when a telephone handset connected to home wiring 140 goes into an off-hook condition. As with the previously described first embodiment, the voltage supplied by VoIP converter 122 as represented by voltage source 310 drops from a range of 45 to 50 volts to a range of 7 to 14 volts. When this drop in voltage occurs, a transistor interfaced to the home wiring 140 can be used to activate another transistor located in SCT 102. Once the telephone handset returns to an on-hook state, the voltage represented by voltage source 310 from VoIP converter 122 rises and the transistor interface 300 coupled to home wiring 140 will deactivate the transistor located in SCT 102.

As previously mentioned, in some instances, it may be desired to provide a constant sealing current. In an exemplary embodiment, constant sealing current may be provided by way of an SCT 102 configuration corresponding to a series coupled resistor and inductor circuit connected across outside line 150. As will be apparent to those of ordinary skill in the art, values for the inductor and resistor should be chosen in consideration of the operating frequency of the xDSL service and the desired level of sealing current to be supplied.

While the present invention has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and does not preclude inclusion of such modifications, variations, equivalents and/or additions to the present invention as would be readily apparent to one of ordinary skill in the art.

That which is claimed is:

1. A voice over internet protocol (VoIP) adapter for installation in a network interface device (NID) coupling digital subscriber line (DSL) signals from an outside line to premises wiring, comprising:
a sealing current terminator configured to enable sealing current flow through the outside line; and
a high-pass filter configured to couple DSL signals from the outside line to the premises wiring,
whereby the VoIP adapter adaptor permits the use of existing analog telephone equipment coupled to the premises wiring.

2. An adapter as in claim 1, further comprising a sealing current terminator control circuit coupled to said sealing current terminator, whereby sealing current may be selectively enabled through the outside line.

3. An adapter as in claim 2, wherein said sealing current terminator control circuit comprises a relay circuit.

4. An adapter as in claim 3, wherein said relay circuit is activated in dependence on voltage levels impressed on said premises wiring.

5. An adapter as in claim 2, wherein said sealing current terminator control circuit comprises a solid state circuit.

6. An adapter as in claim 5, wherein said solid state circuit is activated in dependence on voltage levels impressed on said premises wiring.

7. An adapter as in claim 6, wherein said solid state circuit comprises a transistor switching circuit.

8. An adapter as in claim 1, wherein said sealing current terminator is configured to enable constant sealing current flow.

9. An adapter as in claim 8, where said sealing current terminator comprises a series coupled resistor and inductor.

10. An adapter as in claim 2, wherein said sealing current terminator control circuit comprises a timer circuit configure to enable intermittent sealing current flow.

11. An adapter as in claim 10, wherein said timer circuit is configured to be reset upon detection of a predetermined voltage level applied to the premises wiring.

12. A voice over internet protocol (VoIP) enabled system adapted to couple digital subscriber line (DSL) signals from an outside line to premises wiring, comprising:
a network interface device (NID); and
a VoIP adapter mounted in said NID, said VoIP adapter comprising:
a sealing current terminator configured to enable sealing current flow through the outside line; and
a high-pass filter configured to couple DSL signals from the outside line to the premises wiring,
whereby the VoIP enabled system permits the use of existing analog telephone equipment coupled to the premises wiring.

13. A voice over internet protocol (VoIP) enabled system as in claim 12, further comprising a sealing current terminator control circuit coupled to said sealing current terminator, whereby sealing current through the outside line may be selectively enabled.

14. A voice over internet protocol (VoIP) enabled system as in claim 13, wherein said sealing current terminator control circuit is activated in dependence on voltage levels impressed on said premises wiring.

15. A voice over internet protocol (VoIP) enabled system as in claim 14, wherein said sealing current terminator control circuit comprises a solid state circuit.

16. A voice over internet protocol (VoIP) enabled system as in claim 14, wherein said sealing current terminator control circuit comprises a relay circuit.

17. A voice over internet protocol (VoIP) enabled system as in claim 13, wherein said sealing current terminator control circuit comprises a timer circuit.

18. A voice over internet protocol (VoIP) enabled system as in claim 17, wherein said timer circuit is configured to be reset upon detection of a predetermined voltage level applied to the premises wiring.

19. A voice over internet protocol (VoIP) enabled system as in claim 12, further comprising:
a VoIP to plain old telephone system (POTS) converter coupled to the premises wiring;
at least one low-pass filter; and
at least one analog POTS device coupled to the premises wiring by way of said low-pass filter.

20. A voice over internet protocol (VoIP) enabled system as in claim 12, wherein said sealing current terminator is configured to enable a constant sealing current flow through the outside line.
